(19) United States
(12) Patent Application Publication
(10) Pub. No.: US 2017/0061462 A1
(43) Pub. Date: Mar. 2, 2017

(54) RELAXING POLICY RULES FOR REGULATING THE PRESENTATION OF SPONSORED CONTENT TO A USER OF AN ONLINE SYSTEM

(71) Applicant: Facebook, Inc., Menlo Park, CA (US)

(72) Inventors: Anand Sumatilal Bhalgat, Mountain View, CA (US); Tanmoy Chakraborty, San Mateo, CA (US); Xiaoyu Li, Milpitas, CA (US); Ke Pan, Sunnyvale, CA (US)

(21) Appl. No.: 14/839,885

(22) Filed: Aug. 28, 2015

(51) Int. Cl. G06Q 30/02; H04L 12/58

(52) U.S. Cl. CPC G06Q 30/0225; H04L 51/32; G06Q 30/0248; G06Q 30/0275

(57) ABSTRACT

An online system applies advertising policies regulating presentation of sponsored content to its users. For example, advertising policies may prevent the presentation of advertisements in certain positions content feeds. The online system may relax an advertising policy for an advertisement meeting certain criteria, such as a likelihood of a user interacting with the advertisement or a predicted value of presenting the advertisement. If the online system relaxes an advertising policy for an advertisement, the online system computes a penalty incurred by the advertisement for violating the advertising policy. The online system computes a value for presenting a candidate feed presenting the advertisement in a position violating the advertising policy and a value for an alternative feed presenting the advertisement in a position complying with the advertising policy. The online system selects the candidate feed or the alternative feed for presentation to the user by comparing the values.

### BACKGROUND

This invention relates generally to online systems, and more specifically to presenting content to an online system user.

An online system, such as a social networking system, allows its users to connect to and to communicate with other users of the online system. Users may create profiles on an online system that are tied to their identities and include information about the users, such as interests and demographic information. The users may be individuals or entities such as corporations or charities. Online systems allow users to easily communicate information and share content with other online system users by providing organic content on an online system for presentation to other users. Organic content posted on an online system includes declarative information provided by a user, such as stories, status updates, and location check-ins, as well as photos, videos, and any other information a user wishes to share with additional users of the online system. An online system may also generate organic content for presentation to a user, such as content describing actions taken by other users on the online system connected to the user.

Additionally, entities such as businesses may sponsor presentation of content items via an online system to gain public attention for the entity's products or services or to persuade online system users to take an action regarding the entity's products or services. Many online systems receive compensation from an entity for presenting online system users with certain types of sponsored content items provided by the entity. Frequently, online systems charge an entity for each presentation of sponsored content to an online system user (e.g., for each “impression” of sponsored content) or for each interaction with sponsored content by an online system user. For example, an online system receives compensation from an entity each time a content item provided by the entity is displayed to a user on the online system or each time a user is presented with a content item on the online system and the user interacts with the content item (e.g., clicks on a link included in the content item) or performs another action after being presented with the content item.

Online systems commonly present a user with feeds of content that include both sponsored and organic content selected for presentation to a user by the online system based on measures of relevance to the user. For example, a user is presented with a newsfeed that includes stories describing actions taken by other users connected to the user on the online system and advertisements selected for the user based on declared interests of the user. However, in certain circumstances, presenting sponsored and organic content together in the same feed of content may impair a user's experience with the feed, which reduces the likelihood of the user interacting with the feed or with individual content items presented in the feed. For example, placing multiple sponsored content items in positions of a feed that are within a threshold distance of each other may frustrate a user primarily interested in viewing organic content items in the feed.

To encourage user interaction with presented content, online systems commonly apply policy rules regulating presentation of sponsored content to their users. For example, policies applied by an online system prevent presentation of sponsored content in certain positions in a feed of content to prevent a user from becoming overwhelmed with the sponsored content. However, conventional methods for online systems to apply policies do not account for certain circumstances where it may be advantageous to present sponsored content to a user in positions of a feed of content that would violate a policy applied by the online system. For example, conventional application of policies by an online system prevent presentation of sponsored content in positions of a feed presented to a user that would violate a policy of the online system even when presenting the sponsored content in the positions would increase a likelihood of the user interacting with the feed. As a result, conventional application of policies regulating presentation of sponsored content to online system users may reduce the likelihood of a user interacting with a feed of content or with individual content items presented in a feed of content in some circumstances.

### SUMMARY

To increase user interaction with content, an online system applies one or more advertising policies to regulate the presentation of sponsored content (or “advertisements”) to its users. Advertising policies may prevent the presentation of advertisements in certain positions in feeds of content (or “content feeds”) that also include organic content, which is content for which the online system does not receive compensation in exchange for presenting to its users. For example, one or more advertising policies prevent presentation of advertisements in certain positions of the feed of content (e.g., in an initial position in the feed of content). As another example, one or more advertising policies specify a minimum distance between advertisements presented in a feed of content; an advertising policy may specify a minimum number of organic content items presented between advertisements in the feed or may specify a minimum number of positions between advertisements in the feed. In certain circumstances, the online system may relax one or more advertising policies regulating presentation of an advertisement to a user, allowing the advertisement to be presented to the user in a position in a feed of content that would otherwise violate an advertising policy applied by the online system.

When generating a feed of content for presentation to a user, the online system relaxes one or more advertising policies for advertisements satisfying at least a threshold number of criteria (e.g., a threshold amount of compensation received by the online system for presenting an advertisement, a threshold similarity of the advertisement to one or more advertisements previously presented to the user, or a threshold likelihood of the user interacting with the advertisement). In one embodiment, the online system calculates a value associated with presenting an advertisement in the feed based on a bid amount associated with the advertisement (e.g., a specified amount of compensation received by the online system in exchange for presenting the advertisement to the user) and an estimated amount of interaction with the advertisement by the user. If the value satisfies one or more conditions (e.g., equals or exceeds a threshold value or has at least a threshold position in a ranking of values associated with advertisements previously presented to the user), the online system may relax one or more advertising policies regulating placement of the advertisement in one or more positions in the feed when generating the feed for presentation to the user. In various embodiments, the calculated values may be based on amounts of revenue received or expected to be received by the online system for presenting advertisements to the user and/or amounts of or predicted amounts of user interaction with advertisements or other content items presented to the user.

If the online system relaxes one or more advertising policies for an advertisement when generating the feed of content, the online system computes a penalty incurred by the advertisement for violating one or more of the advertising policies that are relaxed. The penalty may be based on prior interactions by the user with advertisements previously presented to the user, such as advertisements having at least a threshold percentage or threshold number of characteristics matching characteristics of the advertisement. In some embodiments, the penalty is based at least in part on a difference between user interaction with feeds of content including advertisements with at least the threshold number or percentage of characteristics matching characteristics of the advertisement and user interaction with feeds of content not including advertisements. Alternatively, the penalty is based on a distribution of revenue received by the online system from presenting a set of advertisements having at least a threshold number or percentage of characteristics matching or similar to characteristics of the advertisement and a coefficient associated with a subset of the distribution (e.g., a specified percentile of the distribution). Additionally, the penalty may be based on a degree to which presenting the advertisement in a position of the feed violates the advertising policies. In some embodiments, the penalty is inversely related (e.g., inversely proportional) to the frequency with which the online system allows violation of an advertising policy when generating feeds of content for presentation to users.

In various embodiments, the online system determines a value of a candidate feed of content that presents the advertisement in a position that violates an advertising policy and also determines an additional value of an alternative candidate feed of content that presents the advertisement in a position that does not violate an advertising policy. When determining the value of the candidate feed that presents the advertisement in the position that violates the advertising policy, the online system reduces the bid amount of the advertisement by the penalty. Additionally, the online system applies various position discounts to the advertisements and other content items included in the candidate feed based on the positions in the candidate feed in which the advertisement and other content items are presented. Accounting for the penalty allows the online system to account for a potential decrease in user interaction from presenting the advertisement in a position of the candidate feed that violates the advertising policy. Similarly, position discounts based on positions in the alternative candidate feed in which content items or advertisements are presented in the alternative candidate feed are used when determining the additional value. Hence, the value of the candidate feed and the additional value of the additional candidate feed are based at least in part on an expected amount of interaction with the candidate feed and with the additional candidate feed, respectively, by the user. The online system compares the value and the additional value and presents the candidate feed or the alternative candidate feed to the user based on the comparison. For example, the online system identifies a greater of the value and the additional value and presents the candidate feed or the alternative candidate feed associated with the greater of the value and the additional value.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for relaxing policy rules for regulating the presentation of sponsored content to a user of an online system, in accordance with an embodiment.

FIG. 4 is an example of a candidate feed of content including an advertisement in a position that violates an advertising policy and an alternative candidate feed of content including the advertisement in a position that complies with the advertising policy, in accordance with an embodiment.

FIG. 5 is an example of calculating a penalty associated with violating an advertising policy based on a difference in user interaction with feeds of content each presenting an advertisement in different positions, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

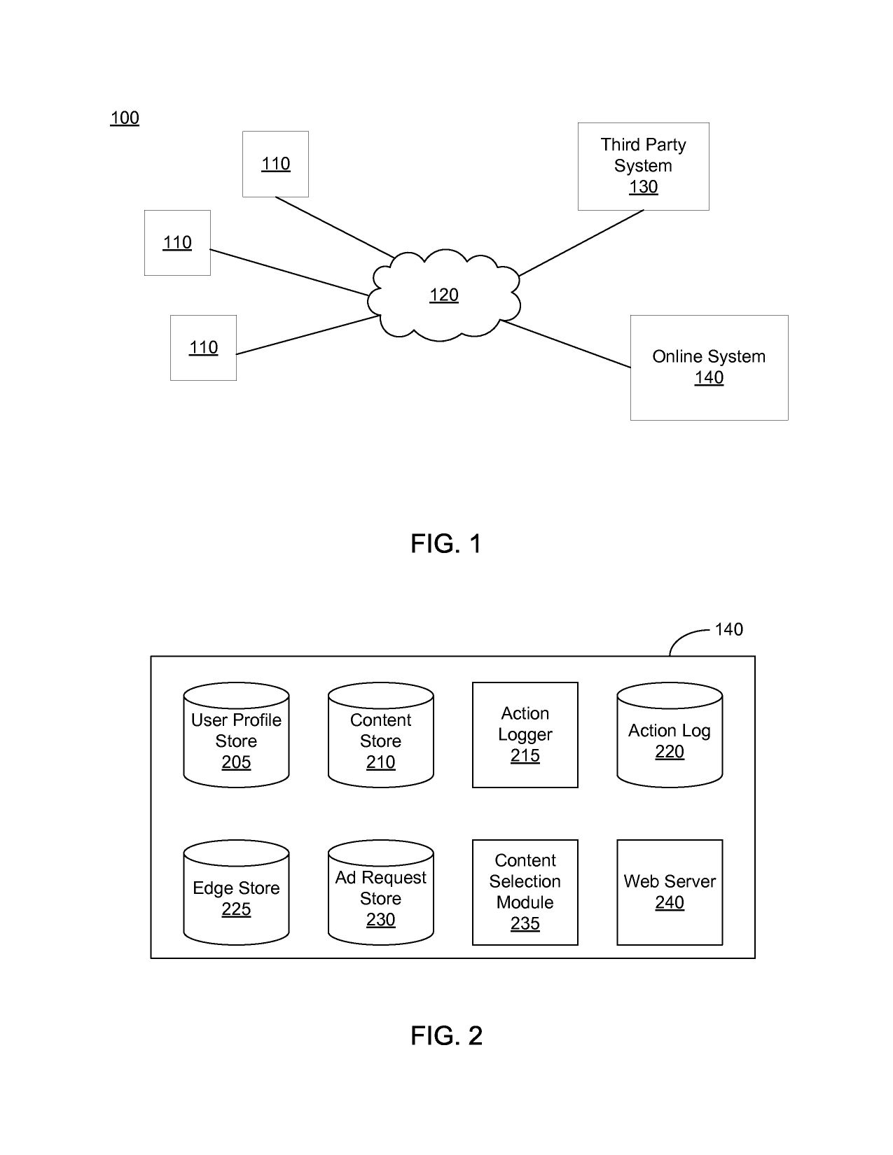

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein can be adapted to online systems that are social networking systems, content sharing networks, or other systems providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

In some embodiments, one or more of the third party systems 130 provide content to the online system 140 for presentation to users of the online system and provide compensation to the online system 140 in exchange for presenting the content. For example, a third party system 130 provides advertisement requests, which are further described below in conjunction with FIG. 2, including advertisements for presentation and amounts of compensation provided by the third party system 130 for presenting the advertisements to the online system 140. Other sponsored content. Other types of sponsored content may be provided by a third party system 130 to the online system 140 for presentation by the online system 140 in exchange for compensation from the third party system 130. Sponsored content from a third party system 130 may be associated with the third party system 130 or with an entity on whose behalf the third party system 130 operates.

FIG. 2 is a block diagram of an architecture of the online system 140. The online system 140 shown in FIG. 2 includes a user profile store 205, a content store 210, an action logger 215, an action log 220, an edge store 225, an advertisement (“ad”) request store 230, a content selection module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity. In some embodiments, the brand page associated with the entity's user profile may retrieve information from one or more user profiles associated with users who have interacted with the brand page or with other content associated with the entity, allowing the brand page to include information personalized to a user when presented to the user.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 for storing in the action log 220 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or a particular user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An ad request includes advertisement content, also referred to as an “advertisement,” and a bid amount. The advertisement is text, image, audio, video, or any other suitable data presented to a user. In various embodiments, the advertisement also includes a landing page specifying a network address to which a user is directed when the advertisement content is accessed. The bid amount is associated with an ad request by an advertiser and is used to determine an expected value, such as monetary compensation, provided by the advertiser to the online system 140 if an advertisement in the ad request is presented to a user, if the advertisement in the ad request receives a user interaction when presented, or if any suitable condition is satisfied when the advertisement in the ad request is presented to a user. For example, the bid amount specifies a monetary amount that the online system 140 receives from the advertiser if an advertisement in an ad request is displayed. In some embodiments, the expected value to the online system 140 of presenting the advertisement may be determined by multiplying the bid amount by a probability of the advertisement being accessed by a user.

Additionally, an ad request may include one or more targeting criteria specified by the advertiser. Targeting criteria included in an ad request specify one or more characteristics of users eligible to be presented with advertisement content in the ad request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users who have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an ad request. As another example, targeting criteria identifies users having a connection to another user or object or having a particular type of connection to another user or object.

The content selection module 235 selects one or more content items for communication to a client device 110 to be presented to a user. Content items eligible for presentation to the user are retrieved from the content store 210, from the ad request store 230, or from another source by the content selection module 235, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 235 includes content items eligible for presentation to the user in one or more selection processes, which identify a set of content items for presentation to the user. For example, the content selection module 235 determines measures of relevance of various content items to the user based on characteristics associated with the user by the online system 140 and based on the user's affinity for different content items. Information associated with the user included in the user profile store 205, in the action log 220, and in the edge store 225 may be used to determine the measures of relevance. Based on the measures of relevance, the content selection module 235 selects content items for presentation to the user. As an additional example, the content selection module 235 selects content items having the highest measures of relevance or having at least a threshold measure of relevance for presentation to the user. Alternatively, the content selection module 235 ranks content items based on their associated measures of relevance and selects content items having the highest positions in the ranking or having at least a threshold position in the ranking for presentation to the user.

Content items selected for presentation to the user may include advertisements from ad requests or other content items associated with bid amounts. The content selection module 235 uses the bid amounts associated with ad requests when selecting content for presentation to the user. In various embodiments, the content selection module 235 determines an expected value associated with various ad requests (or other content items) based on their bid amounts and selects advertisements from ad requests associated with a maximum expected value or associated with at least a threshold expected value for presentation. An expected value associated with an ad request or with a content item represents an expected amount of compensation to the online system 140 for presenting an advertisement from the ad request or the content item. For example, the expected value associated with an ad request is a product of the ad request's bid amount and a likelihood of the user interacting with the ad content from the ad request. The content selection module 235 may rank ad requests based on their associated bid amounts and select advertisements from ad requests having at least a threshold position in the ranking for presentation to the user. In some embodiments, the content selection module 235 ranks both content items not associated with bid amounts and ad requests in a unified ranking based on bid amounts associated with ad requests and measures of relevance associated with content items and ad requests. Based on the unified ranking, the content selection module 235 selects content for presentation to the user. Selecting ad requests and other content items through a unified ranking is further described in U.S. patent application Ser. No. 13/545,266, filed on Jul. 10, 2012, which is hereby incorporated by reference in its entirety.

For example, the content selection module 235 receives a request to present a feed of content (also referred to herein as a “content feed”) to a user of the online system 140. The feed may include one or more advertisements as well as content items, such as stories describing actions associated with other online system users connected to the user. The content selection module 235 accesses one or more of the user profile store 205, the content store 210, the action log 220, and the edge store 225 to retrieve information about the user. For example, stories or other data associated with users connected to the identified user are retrieved. Additionally, one or more ad requests may be retrieved from the ad request store 230. The retrieved content items and ad requests are analyzed by the content selection module 235 to identify candidate content that is likely to be relevant to the identified user. For example, content items associated with users not connected to the identified user or content items associated with users for whom the identified user has less than a threshold affinity are discarded as candidate content. Based on various criteria, the content selection module 235 selects one or more of the content items or ad requests identified as candidate content for presentation to the identified user. The selected content items or advertisements from selected ad requests are included in a feed of content that is presented to the user. For example, the feed of content includes at least a threshold number of content items describing actions associated with users connected to the user via the online system 140.

In various embodiments, the content selection module 235 presents content to a user through a feed including a plurality of content items selected for presentation to the user. One or more advertisements may also be included in the feed. The content selection module 235 may also determine an order in which selected content items or advertisements are presented via the feed. For example, the content selection module 235 orders content items or advertisements in the feed based on likelihoods of the user interacting with various content items or advertisements.

When generating a feed of content items for presentation to a user of the online system 140, the content selection module 235 may place content items into positions in the feed of content subject to one or more policies that restrict certain content items from being presented in specified positions in feeds of content. For example, an advertising policy prevents presentation of sponsored content in certain positions of a content feed (e.g., a first or top position in the feed). However, the content selection module 235 may relax or ignore one or more of the advertising policies for content items satisfying a threshold number of criteria. For example, the content selection module 235 generates a content feed including an advertisement in a position that violates an advertising policy if a value associated with presenting the advertisement in the position exceeds a threshold value.

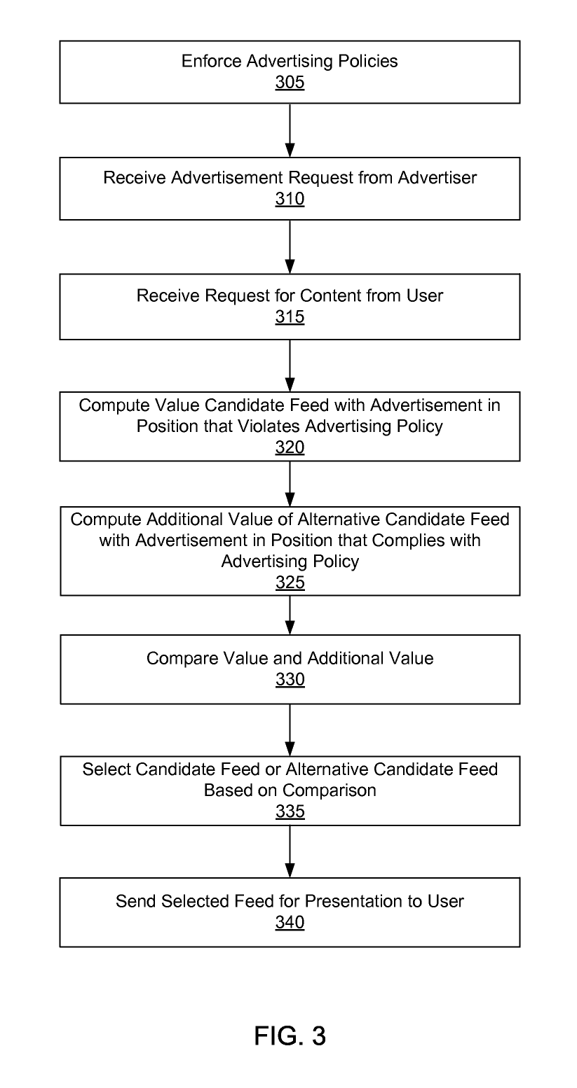

The value associated with presenting an advertisement may be associated with the advertisement itself (e.g., a bid amount associated with the advertisement) or with the content feed in which the advertisement will be presented (e.g., an engagement score indicating an amount of user interaction with the content feed). In various embodiments, the value of the advertisement is adjusted by a penalty computed by the online system 140 for violating an advertising policy. The threshold value to which the value associated with presenting the advertisement may be based on a predicted amount of user interaction with the advertisement and/or content feed including the advertisement, an amount of compensation expected to be received by the online system 140 for presenting the advertisement to the user, an amount of compensation received by the online system 140 for presenting other advertisements to the user, a similarity of the advertisement to one or more advertisements previously presented to the user, or a likelihood of the user interacting with the advertisement and/or content feed including the advertisement. Relaxing one or more advertising policies for content items satisfying a threshold number of criteria is further described below in conjunction with FIGS. 3-5.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

### Relaxing Policy Rules Regulating Presentation of Sponsored Content to an Online System User

FIG. 3 is a flowchart of one embodiment of a method for relaxing policy rules regulating presentation of sponsored content to a user of an online system 140. In other embodiments, the method may include different and/or additional steps than those shown in FIG. 3. Additionally, steps of the method may be performed in different orders than the order described in conjunction with FIG. 3 in various embodiments.

The online system 140 enforces 305 one or more advertising policies that regulate the presentation of sponsored content (e.g., advertisements) to its users to improve engagement with the online system 140 and to increase the likelihood of users interacting with feeds of content (also referred to as “content feeds”) presented by the online system 140. Advertising policies enforced 305 by the online system 140 describe one or more conditions preventing presentation of sponsored content in certain positions in feeds of content, such as feeds of content that also include organic content. For example, one or more advertising policies prevent presentation of advertisements in certain positions of a feed of content presented to a user (e.g., a first or an initial position in the feed of content). If the online system 140 generates a vertically-scrollable content feed including a single column and multiple rows that each correspond to a position in which one or more content items are presented, the online system 140 enforces 305 the prior example advertising policy to prevent presentation of an advertisement in the top row (i.e., the initial position) of the content feed. This advertising policy causes a content item for which the online system 140 does not receive compensation in exchange for presenting to a user (i.e., an “organic content item”) to be presented in the initial position of the content item, which may increase a likelihood of the user interacting with the content feed.

In another example, one or more advertising policies specify a threshold distance between sponsored content items presented in a feed of content. The threshold distance may be identified as a number of positions between advertisements, a number of organic content items presented between advertisements, a number of pixels between advertisements, or any other suitable unit of measurement. For example, an advertising policy specifies a minimum number of positions in a content feed between advertisements presented in the feed. If the online system 140 generates a vertically-scrollable content feed including a single column of multiple rows that each correspond to a position in which one or more content items are presented, enforcing 305 the one or more advertising policies causes the online system 140 to prevent advertisements from being presented in positions that are within the specified minimum number of positions from each other.

As another example, an advertising policy specifies a minimum number of organic content items presented between sponsored content items in a content feed. If the online system 140 generates a content feed including a single column of multiple rows that each correspond to a position in which one or more content items are presented to a user, the online system 140 enforces 305 the advertising policy to prevent presentation of an advertisement in a position in the feed that is not separated from a position in the feed presenting another advertisement in the feed by at least the specified number of organic content items. As multiple content items may be presented in a single position in a feed of content in some embodiments or a content item may be presented using multiple positions in the feed of content in other embodiments, the number of positions and the number of content items between advertisements presented in a feed of content may differ in certain embodiments.

Additionally, one or more advertising policies may prevent presentation of sponsored content in portions of a content feed that have at least a threshold visibility or at least a threshold likelihood of receiving user interaction. For example, if the online system 140 determines that the first five positions in a feed of content are likely to receive at least threshold amount of user interaction, an advertising policy prevents presentation of an advertisement in the first five positions of the feed of content to increase the likelihood of the user interacting with organic content items when enforced 305 by the online system 140. As another example, an advertising policy prevents presentation of an advertisement in a position of a content feed having at least a threshold prominence or visibility to a user when presented on a client device 110. For example, an advertising policy specifies a minimum distance from a reference position in the feed of content item having a maximum prominence when presented on a client device 110 (e.g., a reference position in a particular region of a display device of the client device 110). When the online system 140 enforces 305 the advertising policy in the preceding example, a content feed generated by the online system 140 does not include advertisements in positions of the content feed that are less than the minimum distance from the reference position when the content item is initially presented to a user; however, user interaction with the content feed (e.g., scrolling the content feed) may cause a position in which an advertisement is presented to be within the minimum distance from the reference position after initial presentation of the content feed.

The online system 140 receives 310 an ad request from an entity, such as an advertiser, including an advertisement, a bid amount and one or more targeting criteria specified by the advertiser for identifying users eligible to receive the advertisement. As further described above in conjunction with FIG. 2, the advertisement includes content for presentation to a user of the online system 140 and the bid amount specifies an amount of compensation provided by the entity from which the ad request was received 310 to the online system 140 if the advertisement included in the ad request is presented to one or more online system users or if one or more online system users perform one or more specific interactions when presented with the advertisement. Additionally, the ad request may have additional characteristics, such as an identifier of an advertising campaign, a description of the content of the advertisement, a landing page associated with the advertisement, and one or more topics associated with the advertisement. The online system 140 stores the ad request for subsequent retrieval.

The online system 140 receives 315 a request to present a feed of content including a plurality of content items to a user of the online system 140. For example, the online system 140 receives 315 a request from a client device 110 associated with a user of the online system 140 to present a feed of content (e.g., stories describing actions taken by additional users connected to the user on the online system 140, content provided to the online system 140 by additional users of the online system 140). As another example, the online system 140 receives 315 a request from a client device 110 associated with the user to refresh a feed of content provided by the online system 140 to the client device 110. In response to receiving 315 the request, the online system 140 selects content items for presentation to the user. For example, the online system 140 selects organic content items and sponsored content items eligible for presentation to the user and selects content from the organic content items and sponsored content items eligible for presentation to the use based on attributes of the content items and characteristics of the user, as described above in conjunction with FIG. 2.

Organic content items are content items for which the online system 140 does not receive compensation in exchange for presenting to the user. As described above in conjunction with FIG. 2, organic content items may be selected for presentation to the user based on measures of relevance to the user, which may be based at least in part on engagement scores specifying amounts of predicted interaction with the content item by the user. In some embodiments, engagement scores may be based on a historical number of interactions with a content item by various users of the online system 140 (e.g., all users of the online system 140, users of the online system 140 having specific characteristics, or users of the online system 140 having a threshold similarity to the user from which the request for content was received 315). Sponsored content items are content items for which the online system 140 receives compensation from entities associated with the content items in exchange for presenting the content items to a user, such as an advertisement. As described above in conjunction with FIG. 2, the online system 140 may select advertisements for presentation to the user based at least in part on bid amounts associated with the advertisements, and may account for engagement scores associated with various advertisements that are based on a likelihood of the user interacting with the advertisements.

After selecting the plurality of content items for presentation to the user, the online system 140 generates a candidate feed of content including a plurality of positions, with one or more of the selected content items included in each of the positions. When generating the candidate feed of content, the online system 140 associates one or more of the selected content items with each position in the candidate feed based on values associated with content items, which include advertisements, and position discounts associated with positions in the candidate feed. In some embodiments, the online system 140 associates minimum values with certain positions, so content items having values less than a minimum value associated with a position are not associated with the position in the candidate feed. When associating advertisements with positions in the candidate feed, the online system 140 accounts for one or more advertising policies enforced 305 by the online system 140. For example, enforcement of one or more advertisement policies prevents advertisements from being associated with certain positions in the candidate feed. In addition to enforcing 305 one or more advertisement policies, the online system 140 also determines whether an advertisement selected for presentation to the user satisfies a threshold number of criteria causing the online system 140 to relax one or more of the advertising policies. If the advertisement satisfies at least the threshold number of criteria, the online system 140 may associate the advertisement with a position in the candidate feed that violates one or more of the relaxed advertising policies and computes 320 a value associated with presenting the candidate feed including the advertisement in the position that violates one or more of the relaxed advertising policies to the user.

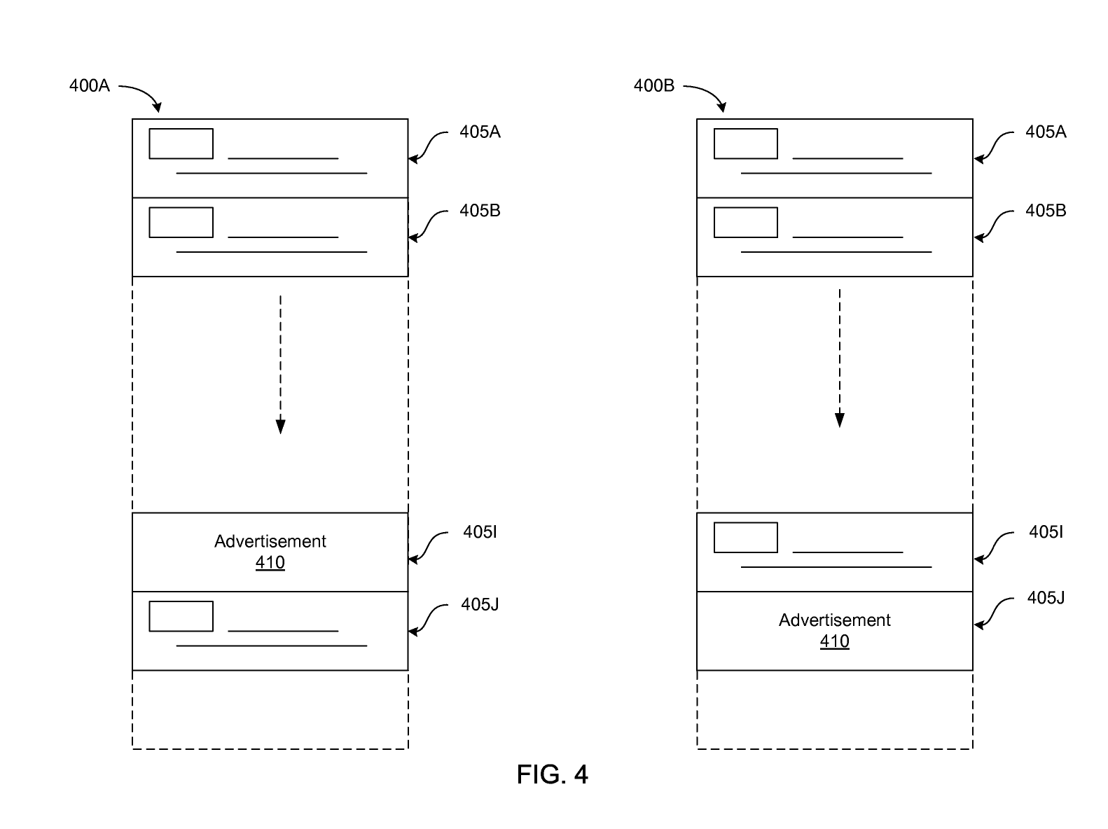

Referring to FIG. 4, the online system 140 generates a candidate feed of content 400A including a plurality of positions 405A-J that each present one or more content items to a user. Hence, each position 405A-J in the candidate feed 400A is associated with one or more content items selected for presentation to the user. In the example of FIG. 4, an advertisement 410 satisfies at least a threshold number of criteria, so the online system 140 associates the advertisement 410 with a position 4051 in the candidate feed of content 400A that violates one or more advertising policies enforced 305 by the online system 140. For example, the online system 140 enforces 305 an advertising policy preventing presentation of one or more advertisements in the first nine positions of a feed of content that includes organic content. When generating the candidate feed of content 400A, the online system 140 associates one or more content items with each position 405A-J of the candidate feed 400A based on one or more criteria. In the example of FIG. 4, if an advertisement eligible to be presented to the user satisfies criteria for association with one of the first nine positions 405A-I, the online system 140 determines whether the advertisement satisfies at least a threshold number or a threshold percentage of criteria for relaxing the advertising policy.

Example criteria for relaxing one or more advertising policies enforced 305 by the online system 140 include: a threshold amount of compensation received by or expected to be received by the online system 140 for presenting the advertisement 410 to the user, a threshold position in a ranking of amounts of revenue received by the online system 140 for presenting a set of advertisements to the user, a threshold position in a ranking of expected amounts of revenue received by the online system 140 for presenting other advertisements to the user, a threshold measure of similarity between the advertisement 410 and one or more advertisements previously presented to the user, and a threshold likelihood of the user interacting with the advertisement 410. If the online system 140 determines the advertisement 410 satisfies a threshold number or a threshold percentage of criteria for relaxing one or more advertising policies enforced 305 by the online system 140, the advertisement 410 may be associated with one of the positions 405A-I in the candidate feed of content 400A that would otherwise violate an advertising policy.

In various embodiments, when determining whether an advertisement satisfies a threshold number of or a threshold percentage of criteria for relaxing an advertising policy, the online system 140 calculates a value associated with presenting the advertisement to the user and may relax the advertising policy if the calculated value equals or exceeds a threshold value. In some embodiments, the calculated value is based on a bid amount associated with the advertisement 410 and a likelihood of the user interacting with the advertisement 410. For example, the threshold value is an amount of compensation expected to be received by the online system 140 for presenting the advertisement 410 to the user and the calculated value is a product of the advertisement's bid amount and a likelihood of the user interacting with the advertisement 410 or a likelihood of the user performing certain interactions with the advertisement 410. The likelihood of the user interacting with the advertisement 410 or performing certain interactions with the advertisement may be based on a number of previous interactions by the user or by additional users having at least a threshold number or threshold percentage of characteristics matching characteristics of the user with the advertisement 410 or with additional advertisements having at least threshold measure of similarity to the advertisement 410. In other embodiments, the online system 140 calculates a value associated with presenting the advertisement 410 to the user by applying a conversion factor to one or more of the bid amount included in the advertisement 410 and to an expected amount of interaction by the user with the advertisement 410, which may be based on prior interactions with the advertisement 410 or with additional advertisements having at least a threshold number or a threshold percentage of characteristics matching characteristics of the advertisement 410 by the user or by additional users having at least a threshold number or a threshold percentage of characteristics matching characteristics of the user. Application of the conversion factor converts the bid amount and the expected amount of interaction into a common unit of measurement, allowing combination of the bid amount and the expected amount of interaction.

As another example, a criterion for relaxing an advertising policy is the value calculated for the advertisement 410 having at least a threshold position in a ranking of values associated with presenting a set of advertisements. Advertisements in the set may share a threshold number or a threshold percentage of characteristics with the advertisement. For example, the online system 140 relaxes an advertising policy if a value associated with the advertisement 410 is within a specified percentile in a ranked distribution of values associated with a set of advertisements previously presented to the user or to other users. In some embodiments, the value associated with the advertisement 410 is a predicted amount of interaction with the advertisement by the user and the values in the ranked distribution of values are average amounts of interaction by the user with each advertisement in the set of previously presented advertisements. For example, the online system 140 retrieves a ranked distribution of a number of interactions by the user with advertisements presented to the user within a particular time interval (e.g., over the past twelve months) and relaxes an advertising policy if the predicted amount of user interaction with the advertisement is in the 90^{th} percentile (i.e., the top 10%) of the distribution. The predicted amount of user interaction with the advertisement 410 may be based on a number of previous interactions by the user with additional advertisements having at least a threshold measure of similarity to the advertisement 410 (e.g., at least a threshold number of characteristics matching characteristics of the advertisement 410, at least a threshold percentage of characteristics matching characteristics of the advertisement 410).

In other embodiments, the value associated with the advertisement 410 is an amount of compensation received or expected to be received by the online system 140 for presenting the advertisement 410, which is ranked among average amounts of revenue generated from presenting various advertisements in a set to the user or to other users. For example, the online system 140 predicts an amount of revenue to be received by the online system 140 from presenting the advertisement to the user (e.g., based on a predicted amount of interaction with the advertisement by the user and a bid amount associated with the advertisement 410 specifying an amount of compensation received by the online system 140) and ranks the predicted amount of revenue in a ranked distribution of revenue earned by the online system 140 from presenting advertisements in a set of advertisements to the user, or to other users, during a specified time interval (e.g., six months from a current time). If the predicted amount of revenue has at least a threshold position in the ranked distribution of revenues earned, the online system 140 may relax one or more advertising policies restricting presentation of the advertisement 410 in certain positions of a feed of content. For example, the online system 140 relaxes an advertising policy for advertisements having a value in the ninety eighth percentile of a ranked distribution of revenue generated from a set of advertisements previously presented to the user. Thus, if the online system 140 predicts it will generate $1.84 from presenting the advertisement 410 to the user and the threshold amount of revenue for inclusion in ninety eighth percentile of the ranked distribution of revenue is $1.73, the online system 140 may relax the advertising policy when associating the advertisement 410 with a position in the candidate feed of content 400A, allowing association of the advertisement 410 with a position in the candidate feed of content 400A that would otherwise violate the advertising policy.

In yet another embodiment, a value associated with the advertisement 410 is based on a measure of similarity between the advertisement 410 and one or more advertisements previously presented to the user. For example, online system 140 calculates the value for presenting the advertisement 410 by combining the bid amount of the advertisement and the expected amount of user interaction with the advertisement 410 (or the likelihood of the user interacting with the advertisement 410) and scaling the combination by a measure of similarity between the advertisements and one or more additional advertisements previously presented to the user (e.g. advertisements in the ninety fifth percentile of a distribution of revenue earned from advertisements previously presented to the user). If the value of the advertisement equals or exceeds a threshold value, the online system 140 may relax one or more advertising policies that would otherwise be applied to the advertisement, allowing the advertisement to be associated with one or more positions in the candidate feed of content 400A that would otherwise violate an advertising policy.

If more than one advertisement eligible to be presented to the user satisfies a threshold number or a threshold percentage of criteria for relaxing an advertising policy, the online system 140 selects an advertisement that satisfies the threshold criteria for inclusion in the candidate feed 400A in some embodiments. For example, if three advertisements eligible to be presented to the user satisfy at least the threshold number or the threshold percentage of criteria for relaxing an advertising policy, the online system 140 ranks the advertisements based on their computed values (or their bid amounts, or there expected amounts of user interaction) and selects one of the advertisements to associate with a position in the candidate feed of content 400A that violates an advertising policy based on the ranking. Alternatively, the online system 140 generates multiple candidate feeds that each include a different advertisement eligible for presentation to the user and satisfying at least the threshold number or the threshold percentage of criteria for relaxing an advertising policy associated with positions that violates an advertising policy.

Hence, in various embodiments, the online system 140 relaxes one or more advertising policies regulating placement of the advertisement 410 in a feed of content if the online system 140 determines the advertisement 410 satisfies at least a threshold number or a threshold percentage of criteria. For example, if the online system 140 determines the advertisement 410 is associated with a threshold amount of predicted user interaction, the online system 140 evaluates the advertisement 410 along with other content items for association with a position in the feed that would otherwise cause the advertisement to violate one or more of the relaxed advertising policies. This allows the online system 140 to evaluate the advertisement 410 for association with the position along with other content items based on the value associated with the advertisement 410 and the values associated with the other content items. Hence, an advertisement satisfying at least the threshold number or the threshold percentage of the criteria is evaluated for association with the feed based on its value relative to values of other content items evaluated for association with the position.

If the advertisement 410 satisfies at least the threshold number or the threshold percentage of the criteria for relaxing an advertising policy, the online system 140 associates the advertisement 410 with a position in the candidate feed 400A that violates one or more of the relaxed advertising policies and computes 320 a value associated with presenting the candidate feed 400A to the user. The online system 140 computes 320 the value associated with presenting the candidate feed 400A to the user based on values associated with the advertisement 410 included in the position 4051 that violates a relaxed advertising policy and values associated with the additional content items selected for presentation to the user in the candidate feed 400A. For example, the online system 140 computes 320 the value associated with presenting the candidate feed 400A to the user by combining the value associated with the advertisement 410 included in the position 4051 that violates a relaxed advertising policy and values associated with content items presented in other positions 405 of the candidate feed 400A. Additionally, when computing 320 the value associated with presenting the candidate feed 400A to the user, the online system 140 reduces the value associated with the advertisement 410 included in the position 4051 that violates a relaxed advertising policy by a penalty associated with violating the relaxed advertising policy. Hence, the online system 140 decreases the value for the advertisement 410 determined from its bid amount and expected amount of user interaction by the penalty. Values associated with the additional content items selected for presentation to the user in the candidate feed 400A, which are organic content items, are based on predicted amount of user interaction with each content item. If the candidate feed 400A includes additional advertisements associated with positions that do not violate a relaxed advertising policy, the online system 140 determines values for the additional advertisements based on their bid amounts and expected amounts of user interaction, as described above. In various embodiments, the online system 140 applies position discounts to values of the content items, the value of the advertisement 410 associated with a position that violates a relaxed advertising rule, and values of advertisements presented in positions that do not violate a relaxed advertising rule based on the positions associated with each of the preceding items, which is further described below. The value associated with the candidate feed 400A and values for the content items, for the advertisement 410, and for additional advertisements may be computed 320 in terms of an expected amount of user interaction or in terms of expected monetary compensation.

In various embodiments, the online system 140 trains one or more machine-learned models to compute the values for advertisements and for content items included in a content feed based on information associated with the user (including prior interactions by the user with content items and advertisements) as well as information associated with the content items and the advertisements. Information associated with the user may include a historical amount of revenue earned by the online system 140 from presenting advertisements to the user and historical values associated with content items and advertisements previously presented to the user. Information associated with an advertisement 410 includes: the advertisement's bid amount, previous interactions of the user and other online system users with the advertisement 410, and an amount of revenue earned by the online system 140 for presenting the advertisement to users of the online system 140 during a time interval. Additional contextual information may also be used in some embodiments when computing values for advertisements and content items. Example contextual information includes information describing a date and/or time when an advertisement or content item is to be presented, a type of the content item or advertisement, or any other suitable information.

To compute 320 the value associated with presenting the candidate feed 400A to the user, the online system 140 computes a value of the advertisement 410 included in the position 4051 that violates a relaxed advertising policy. For example, the online system 140 retrieves information describing a bid amount associated with an ad request including the advertisement 410 and calculates the value of the advertisement 410 at least in part on the bid amount. As described above in conjunction with FIG. 2, the bid amount specifies an amount of monetary compensation an advertiser agrees to pay the online system 140 in exchange for presenting the advertisement 410 or in exchange for users of the online system 140 presented with the advertisement 410 performing one or more actions. In some embodiments, the value of the advertisement 410 may also be based on bid amounts associated with ad requests including other advertisements eligible for presentation to the user. For example, the value of the advertisement 410 may be based at least in part on one or more bid amounts of ad requests including additional advertisements eligible for presentation to the user that are lower than the bid amount of the ad request including the advertisement 410.

As described above, the value associated with the advertisement 410 may be determined as a product of the bid amount of the advertisement 410 and a likelihood of the user interacting with the advertisement 410 based on prior interactions by the user with advertisements having at least threshold similarity to the advertisement 410. The likelihood of the user interacting with the advertisement 410 may also be based at least in part on prior interactions with the advertisement 410 or with additional advertisements having at least a threshold similarity to the advertisement 410 by additional users having at least a threshold similarity to the user. For example, if the bid amount associated with the advertisement 410 is $1.00 and there is a 90% likelihood of the user interacting with the advertisement 410, the online system 140 computes a value of $0.90 for presenting the advertisement 410 to the user. In other embodiments, the online system 140 calculates a value associated with presenting the advertisement 410 to the user by applying a conversion factor to one or more of the bid amount included in the advertisement 410 and to an expected amount of interaction by the user with the advertisement 410, which may be based on prior interactions with the advertisement 410 or with additional advertisements having at least a threshold number or a threshold percentage of characteristics matching characteristics of the advertisement 410 by the user or by additional users having at least a threshold number or a threshold percentage of characteristics matching characteristics of the user

To account for a position bias that may influence interactions with content items displayed in different positions in a content feed, the online system 140 applies position discounts to the values of content items in the candidate feed of content 400A based on the positions 405 in the candidate feed 400A associated with various content items. For example, a position discount is based on the position in which a content item is presented in a content feed relative to a reference point in the feed. The position discount associated with a position 405 in the candidate feed 400A may be based at least in part on a distance between the position 405 and a reference position in the candidate feed 400A, such as the upper boundary of the candidate feed 400A or an initial position of the candidate feed 400A (e.g., a topmost position of the candidate feed 400A). For example, different position discounts are associated with different distances from the upper boundary of the candidate feed 400A, so a distance between a position 405 and the upper boundary of the candidate feed 400A determines the position discount applied to a value associated with a content item or an advertisement associated with the position 405. The position discount associated with a position 405 accounts for different likelihoods of the user interacting with content items presented in different positions. Determining a position discount value associated with a position 405 in a feed is further described in U.S. patent application Ser. No. 14/049,429, filed on Oct. 9, 2013, and in U.S. patent application Ser. No. 14/675,009, filed on Mar. 31, 2015, which are each hereby incorporated by reference in their entirety.

Hence, the online system 140 applies a position discount corresponding to a position 4051 in the candidate feed 400A associated with the advertisement 410 to the value of the advertisement 410 when computing 320 the value for presenting the candidate feed 400A to the user. For example, if prior interactions by the user or by additional users with content items presented in position 4051 cause the online system 140 to determine a position discount of 0.85 is associated with position 4051, the online system 140 applies the position discount to the value of the advertisement 410, which reduces the value of the advertisement 410. In some embodiments, the online system 140 multiplies the value of the advertisement 410 by the position discount corresponding to the position 4051 associated with the advertisement 410.

Additionally, to account for a potential decrease in user engagement with the candidate feed 400A from presenting the advertisement 410 in a position that violates one or more advertising policies, the online system 140 computes a penalty incurred by the advertisement 410 for violating one or more of the advertising policies. In some embodiments, the value for the advertisement 410 is decreased by the penalty before a position discount is applied to the value. For example, the penalty is subtracted from the bid amount of the advertisement 410 or multiplied by the bid amount when computing the value for the advertisement 410 but before application of the position discount to the value. Alternatively, the penalty is applied to the value after the position discount is applied to the value. In other embodiments, the online system 140 adjusts the value computed for presentation of the candidate feed 400A by the penalty. For example, the penalty is a subtracted from the value for presentation of the candidate feed 400A is a factor by which the value for presentation of candidate feed 400A is multiplied. In various embodiments, the penalty is based at least in part on prior interactions by the user with advertisements previously presented to the user (e.g., all previously presented advertisements, advertisements presented within a specified time period, or advertisements having at least a threshold similarity to the advertisement 410). For example, the online system 140 retrieves a distribution of values associated with a set of advertisements previously presented to the user and computes a user-specific penalty incurred by the advertisement 410 based on one or more properties of the distribution of values associated with the set of advertisements.

In some embodiments, the penalty incurred by the advertisement 410 is a product of the mean of a distribution of revenue generated from a set of advertisements previously presented to the user and a coefficient associated with a property of the distribution, such as a specific subset or percentile of the distribution. The coefficient may be a factor that yields a threshold value in the distribution of revenue when multiplied by another property of the distribution (e.g., the mean) that corresponds to one or more criteria for relaxing one or more of the advertising policies applied by the online system 140. Hence, in some embodiments, the magnitude of the coefficient is proportional to one or more criteria for relaxing one or more advertising policies. For example, if a criterion for relaxing the advertising policy preventing insertion of the advertisement 410 into the position 4051 in the candidate feed 400A is a predicted amount of revenue earned from the advertisement 410 being in a ninety fifth percentile of a distribution of revenue generated from a set of advertisements previously presented to the user, where the coefficient is 1.3 when the ninety fifth percentile of the distribution is $4.68 and the mean of the distribution is $3.60.

In one embodiment, the coefficient and the penalty are directly related (e.g., proportional) to a degree to which an advertising policy is violated by the advertisement 410. For example, a larger magnitude coefficient is associated with larger violation of one or more advertising policies. As an example, larger coefficients are associated with smaller distances between a position including the advertisement 410 and a position including another advertisement if an advertising policy specifies a minimum distance between positions including advertisements. Thus, larger violations of one or more advertising policies cause the advertisement 410 to incur a larger penalty. In another embodiment, the coefficient and penalty are inversely related to (e.g., inversely proportional to) a frequency with which one or more advertising policies are violated. For example, if the online system 140 relaxes advertising policies less than a threshold number of times, the coefficient has a large magnitude, which increases the penalty incurred by an advertisement violating one or more advertising policies. As an additional example, if the online system 140 frequently relaxes an advertising policy when presenting content, a coefficient associated with violating the advertising policy is low, reducing the penalty incurred by an advertisement for violating the advertising policy.

In some embodiments, the online system 140 computes the penalty based on a predicted amount of interaction with the advertisement 410 by the user. The predicted amount of user interaction with the advertisement 410 may be based on a number or a percentage of interactions with additional advertisements having at least a threshold similarity to the advertisement 410 previously presented to the user or to other users of the online system 140 (e.g., all online system users or online system users having at least a threshold similarity to the user). In one embodiment, the online system computes the penalty based on a difference between a predicted amount of interaction with the advertisement 410 by the user and amounts of interaction with advertisements previously presented to the user. For example, the penalty is based on a difference between a predicted amount of interaction with the advertisement 410 by the user and amounts of interaction by the user with previously presented advertisements in a specified percentile (e.g., the ninetieth percentile) of a distribution of amounts of interactions by the user with a set of previously presented advertisements having a threshold similarity to the advertisement 410.

The online system 140 may determine the penalty based at least in part on a predicted loss of user interaction with the candidate feed 400A caused by presentation of the advertisement 410 in a position that violates one or more of the advertising policies. For example, the online system 140 retrieves information describing interactions of the user with feeds of content previously presented to the user that include advertisements having at least a threshold similarity to the advertisement 410 in various positions in the feeds. The online system 140 determines differences between amounts of interaction by the user with feeds of content including the advertisements having at least the threshold similarity to the advertisement 410 in different positions and predicts a loss of user engagement with the candidate feed 400A based on the identified differences. Based on the predicted losses of user engagement between different feeds of content previously presented to the user, the online system 140 determines the penalty.

In some embodiments, the online system 140 calculates multiple penalties, with each penalty associated with different degrees of violations of an advertising policy. Each penalty may be based on a predicted loss of user engagement with the candidate feed 400A caused by presenting the advertisement 410 in different positions of the candidate feed 400A. For example, each penalty is associated with a different position violating an advertising policy and is based on predicted losses of user interaction from presenting the advertisement 410 in different positions violating the advertising policy. The online system 140 may select a penalty to associate with the advertisement 410 that maximizes the value associated with presenting the candidate feed 400A to the user.

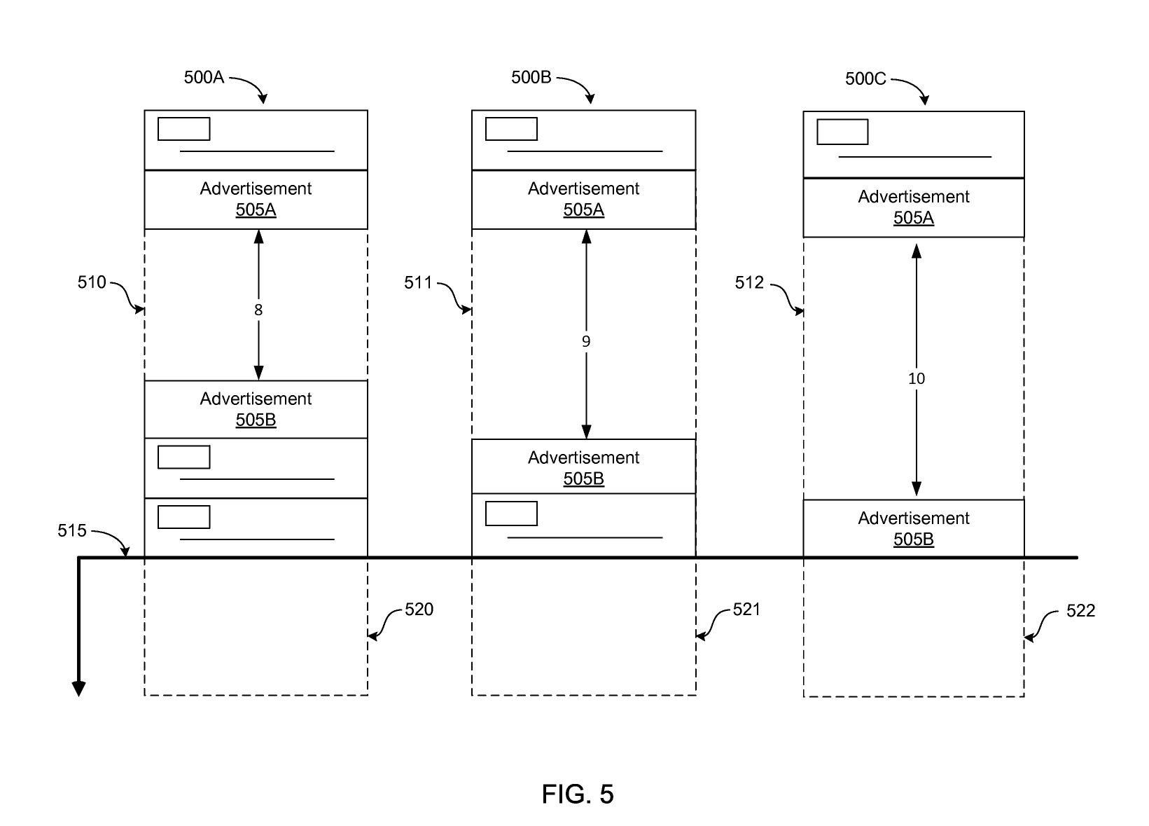

In various embodiments, the online system 140 accounts for interactions by other online system users with feeds of content including an advertisement violating an advertising policy when determining a penalty for the advertisement based on a predicted loss of user engagement with the candidate feed 400A. For example, FIG. 5 shows an example where the online system 140 measures amounts of user interaction with different feeds of content 500A-C presented to one or more additional users of the online system 140. The one or more additional users of the online system 140 may have at least a threshold measure of similarity with the user. In some embodiments, content items and advertisements included in each feed of content 500A-C have at least a threshold measure of similarity with content items and advertisements included in the candidate feed 400A. Each feed of content 500A-C includes an advertisement 505B in a different position of the feed that complies with an advertising policy or violates the advertising policy to a degree. Different feeds of content 500A-C may include the advertisement 505B in positions that violate the advertising policy to different degrees. The online system 140 measures an amount of user interaction with each feed of content 500A-C and bases one or more penalties on a measured loss of user interaction between different feeds of content 500A-C.

Feed of content 500A includes an advertisement 505B in a position in the feed 500A that complies with advertising policies enforced 305 by the online system 140. For example, feed of content 500A includes two advertisements 505A-B that are separated from each other in the feed of content 500A by a distance 510 of ten positions, which complies with an advertising policy specifying a minimum of ten organic content items between consecutive advertisements in the feed of content 505A. In the example of FIG. 5, feed of content 505A associates organic content items with the ten positions between advertisement 505A and advertisement 505B.

However, in FIG. 5, feed of content 500B and feed of content 500C each include advertisement 505B in a position where fewer than 10 organic content items are presented between advertisement 505A and advertisement 505B. Content feed 500B in FIG. 5 includes advertisement 505A and associates advertisement 505B with a position separated from a position associated with advertisement 505A by a distance 511 of nine positions, which violates the advertising policy by one position. Similarly, in FIG. 5, content feed 500C includes advertisement 505A and associates advertisement 505B with a position separated from a position associated with advertisement 505A by a distance 512 of eight positions, which violates the advertising policy by two positions.

Each feed of content 500A-C includes a common reference point 515, and the online system 140 measures user engagement with content items presented in positions that are lower than the reference point 515. The order in which content items are presented in positions above the reference point 515 is affected by the positions associated with the advertisements 505A-B included in the various feeds of content 500A-C. For example, if advertisement 505B in feed of content 500A is presented one position nearer to an initial position in feed of content 500A, an organic content item presented nearer to the initial position in feed of content 500A is displaced and presented one position farther from the initial position in feed of content 500A, resulting in feed of content 500B. Similarly, presenting advertisement 505B two positions nearer to the initial position in feed of content 500A displaces two organic content items so they are presented two positions farther from the initial position in feed of content 500A, resulting in feed of content 500C. However, the order in which content items presented below the reference point 515 in each of feeds of content 500A-C is not affected by the order of the content items above the reference point 515. Hence, content items 520 below the reference point 515 in feed of content 500A, content items 521 below the reference point 515 in feed of content 500B, and content items 522 below the reference point 515 in feed of content 500C have the same order in each of feed of content 500A-C. Hence, determining amounts of user interaction with content items 520, content items 521, and content items 522 in feed of content 500A, feed of content 500B, and feed of content 500C, respectively, allows the online system 140 to determine differences in user engagement between the feeds of content 500A-C caused by presentation of advertisement 500B in positions that differently violate the advertising policy.

The online system 140 computes a value for each of feed of content 500A, feed of content 500B, and feed of content 500C based on user interactions with, respectively, content items 520, content items 521, and content items 522, which are presented below the reference point 515. User interactions include: accessing a content item, sharing a content item with another user, commenting on a comment item, indicating a preference for a content item, request additional information associated with a content item, establish a connection with an object associated with a content item, or any other suitable interaction. Different user interactions with content items presented below the reference point 515 may be differently weighted when computing the value for each feed of content 500A-C. For example, a user sharing a content item presented below the reference point 515 in a feed of content 500A-C with another user of the online system 140 may be associated with a greater weight than a user accessing the content item presented below the reference point 515.

The online system 140 compares the computed values for each feed of content 500A-C and determines a loss of user engagement between different feeds of content 500A-C based on the values for each feed of content 500A-C. As feed of content 500A presents advertisement 505B in a position that complies with the advertising policy, the value of the first feed of content 500A provides a baseline against which values for feed of content 500B and feed of content 500C are compared. A difference between a value for feed of content 500B, which presents advertisement 505B in a position that violates the advertising policy by one position, and the value for feed of content 500A is used by the online system 140 to determine a penalty for presenting an advertisement in a position that violates the advertising policy by one position. Similarly, a difference between a value for feed of content 500C, which presents advertisement 505B in a position that violates the advertising policy by two positions, and the value for feed of content 500A is used by the online system 140 to determine a penalty for presenting an advertisement in a position that violates the advertising policy by two positions. Values for feeds of content 500B-C may reflect a decrease in user engagement with feeds of content 500B-C from presenting the second advertisement 505B in positions violating the advertising policy, which displaces one or more organic content items into less visible positions in feeds of content 500B-C. Displacing the organic content items causes additional navigation through the feeds of content 500B, 500C to access the organic content items, decreasing user interactions with the displaced organic content items.

Based on differences in interaction between feed of content 500A and feed of content 500B as well as between feed of content 500A and feed of content 500C, the online system 140 determines penalties for presenting an advertisement in positions that violate the example advertising policy described in conjunction with FIG. 5. The determined penalties are used by the online system 140 to reduce values for presenting advertisements that violate the example advertising policy described in conjunction with FIG. 5 by different degrees. Determining different penalties associated with different degrees by which an advertising policy is violated allows the online system 140 to more accurately account for changes in user interaction with content feeds when an advertisement in a feed is presented in positions that differently violate an advertising policy.

When computing 320 the value of presenting the candidate content feed 400A to the user, values associated with organic content items in the candidate feed 400A are determined based on a predicted amount of user interaction with each content item in the candidate feed 400A. The online system 140 applies a position discount corresponding to a position 405A-H, 405J in the candidate content feed 400A associated with an organic content item to the value associated with the organic content item. Similarly, the online system 140 determines values for additional advertisements in the candidate content feed 400A, where a value associated with an advertisement associated with a position 405 that does not violate one or more advertising policies is based on expected user interaction with the advertisement and a bid amount associated with the advertisement. The online system applies a position discount corresponding to a position 405 in the candidate content feed 400A associated with the advertisement when computing the value of presenting the candidate content feed 400A to the user.

In various embodiments, the online system 140 determines expected amounts of interactions with organic content items and advertisements based on information stored by the online system 140 describing previous interactions by the user or by additional users having at least at threshold similarity to the user with the content items or advertisements or with additional content items or additional advertisements having at least a threshold measure of similarity with the content items or the advertisements. For example, a value associated with a particular organic content item is based on a number of times or a frequency with which the user views or interacts with content items having a threshold number or a threshold percentage of characteristics matching characteristics of the organic content item. Position discounts are applied to the values for the organic content items and advertisements in the candidate feed of content 400A corresponding to the positions in the candidate feed of content items 400A associated with the organic content items and advertisements, and the online system 140 combines the values after application of the position discounts to compute 320 the value for presenting the candidate feed of content 400A to the user.

Additionally, the online system 140 generates an alternative candidate feed of content including the content items that are included in in the candidate feed of content but has the advertisement associated with a position that does not violate the advertising policy. FIG. 4 shows an example alternative candidate feed 400B that includes the advertisement 410 in a position 405J that complies with the advertising policy enforced 305 by the online system 140 in the example of FIG. 4. In the example of FIG. 4, the alternative candidate feed of content 400B includes the same content items as the candidate feed of content 400A, so the content items in the alternative candidate feed of content 400B are associated with positions 405A-J in the alternative candidate feed 400B that are similar to the positions 405A-J associated with the content items in the candidate feed of content 400A. However, the alternative candidate feed of content 400B associates the advertisement 410 with a position 405J that complies with the advertising policy violated by the position 4051 associated with the advertisement 410A in the candidate feed 400A. For example, position 405J is a tenth position in the alternative candidate feed of content 400B, so the advertisement 410 is associated with a position that complies with the advertising policy enforced 305 by the online system 140 preventing presentation of an advertisement within the first nine positions 405A-J in a feed of content that includes organic content.

The online system 140 computes 325 an additional value associated with the alternative candidate feed of content 400B based on values determined for organic content items in the alternative candidate feed of content 400B, values determined for advertisements in the alternative candidate feed of content 400B, and a value determined for the advertisement 410. As described above, values determined for the advertisement 410 and for additional advertisements are based on bid amounts associated with the advertisement 410 and with the additional advertisements as well as expected interaction by the user with the advertisement 410 and with the additional advertisements. For example, the value associated with the advertisement 410 is based on a bid amount associated with the advertisement 410 and an expected amount of interaction by the user with the advertisement 410. Also as described above, values for organic content items in the alternative candidate feed of content 400B are determined based on expected interaction by the user with the organic content items. In various embodiments, the online system 410 applies position discounts to the values of content items and advertisements in the alternative candidate feed of content 400B corresponding to the positions in the alternative candidate feed of content 400B associated with the content items and the advertisements and combines the values after application of the position discount to compute 325 the additional value associated with the alternative candidate feed of content 400B. As the alternative candidate feed of content 400B associates the advertisement 410 with a position that complies with the advertising policy, no penalty is applied to the value associated with the advertisement 410 or is applied to the additional value associated with the alternative candidate feed of content 400B.

After the online system 140 computes 320 the value associated with the candidate feed of content 400A and computes 325 the additional value associated with the alternative candidate feed of content 400B, the online system 140 compares 330 the value and the additional value and selects 335 the candidate feed of content 400A or the alternative candidate feed of content 400B based on the comparison. In various embodiments, the online system 140 determines which of the value and the additional value is larger and selects 335 the feed of content from the candidate feed of content 400A and the alternative feed of content 400B associated with the larger of the value and the additional value. The online system 140 sends 340 the selected feed of content to a client device 110 for presentation to the user. Alternatively, the online system 140 compares 330 the value for the advertisement 410 included in the candidate feed of content 400A, after applying the penalty to the value, and the value for the advertisement 410 included in the alternative candidate feed of content 400B and selects 335 a feed of content in which the advertisement 410 has a greater value from the candidate feed 400A and the alternative candidate feed 400B.

Hence, the feed of content sent 340 to a client device 110 for presentation includes the advertisement 410 in a position corresponding to whichever of the candidate feed of content 400A or the alternative candidate feed of content 400B that was selected 335. For example, if the value associated with presenting the user with the candidate feed of content 400A associating the advertisement 410 with the position 4051 violating an advertising policy is greater than the additional value associated with the alternative candidate feed of content 400B associating the advertisement 410 with the position 405J complying with the advertising policy, the online system 140 sends 340 the candidate feed of content 400A, in which the advertising policy is relaxed, to the client device 110. Relaxing one or more advertising policies allows the online system 140 to present the user with the advertisement 410 associated with a position that violates an advertising policy but results in a greater expected amount of interaction with a feed of content by the user. Alternatively, if the additional value associated with the alternative candidate feed of content 400B associating the advertisement 410 with a position 405J that complies with the advertising policy is greater than the value associated with the candidate feed of content 400A associating the advertisement 410 with a position 4051 that violates the advertising policy, the online system 140 sends 340 the alternative candidate feed 400B to a client device 110, which enforces 305 the advertising policy to provide the user with a feed of content with which the user is more likely to interact.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a nontransitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a nontransitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
enforcing, at an online system, one or more advertising policies, each advertising policy describing one or more conditions preventing insertion of one or more advertisements into a position in a feed of content;
receiving information describing an advertisement request from an advertiser, the advertisement request including an advertisement and a bid amount;
receiving a request to present a feed of content to a user of the online system, the feed of content including one or more advertisements and a plurality of content items;
computing a value of a candidate feed, the candidate feed including the advertisement in a position that violates one or more of the advertising policies, the value based at least in part on the bid amount of the advertisement, a position discount associated with the position in the feed including the advertisement, a penalty incurred from violating the one or more of the advertising policies, and one or more values associated with the plurality of content items;
computing an additional value of an alternative candidate feed, the alternative candidate feed including the advertisement in an alternative position that complies with the one or more advertising policies, the additional value based at least in part on the bid amount, a position discount associated with the alternative position including the advertisement, and one or more values associated with the plurality of content items;
comparing the value of the candidate feed and the additional value of the alternative candidate feed;
selecting a feed from the candidate feed and the alternative candidate feed based at least in part on the comparison; and
sending the selected feed to a client device for presentation to the user.

2. The method of claim 1, wherein the position that violates one or more of the advertising policies is less than a threshold distance from a position in the candidate feed including an additional advertisement.

3. The method of claim 1, wherein computing the value of the candidate feed comprises:
adjusting the bid amount by the position discount; and
decreasing the adjusted bid amount by the penalty, wherein the penalty is based at least in part on information describing a set of advertisements previously presented to the user by the online system.

4. The method of claim 1, wherein the penalty is proportional to an amount by which the position in the candidate feed including the advertisement violates one or more of the advertising policies.

5. The method of claim 1, wherein the penalty is based at least in part on a predicted amount of decrease in interaction with the candidate feed by the user caused by the position in the candidate feed including the advertisement violating the one or more of the advertising policies.

6. The method of claim 1, wherein a value associated with a content item is based at least in part on predicted amount of user interaction with the content item.

7. The method of claim 1, wherein the penalty is based at least in part on a difference between a predicted amount of interaction with the candidate feed and a predicted amount of interaction with the additional candidate feed.

8. The method of claim 1, wherein the penalty comprises a product a property of a distribution of revenue generated from a set of advertisements previously presented to the user and a coefficient correlated with a specific subset of the distribution.

9. The method of claim 8, wherein the property is a mean of the distribution.

10. A method comprising:
enforcing, at an online system, one or more advertising policies, each advertising policy describing one or more conditions preventing insertion of one or more advertisements into a position in a feed of content;
receiving information describing an advertisement request from an advertiser, the advertisement request including an advertisement and a bid amount;
receiving a request to present a feed of content to a user of the online system, the feed of content including one or more advertisements and a plurality of content items;
determining a penalty for inserting the advertisement into a position in the feed of content that violates one or more of the advertising policies, the penalty based at least in part on information describing a set of advertisements previously presented to the user;
computing a value for the advertisement by decreasing the bid amount by the penalty;
comparing the value to one or more additional values associated with content items eligible for insertion into the position; and
selecting content for insertion into the position based at least in part on the comparison.

11. The method of claim 10, wherein the information describing a set of advertisements previously presented to the user comprises a distribution of revenue generated from presenting the set of advertisements to the user.

12. The method of claim 10, wherein the information describing a set of advertisements previously presented to the user comprises an amount of user interaction with the set of advertisements.

13. The method of claim 10, wherein determining the penalty for inserting the advertisement into the position in the feed of content that violates one or more advertising policies comprises:
calculating an amount of revenue generated from presenting the advertisement to one or more users of the online system; and
determining the penalty responsive to determining the amount of revenue equals or exceeds threshold amount.

14. The method of claim 13, wherein the threshold amount is based at least in part on a specified percentile of a distribution of revenue generated from previously presenting the set of advertisements to the user.

15. The method of claim 10, wherein determining the penalty for inserting the advertisement into the position in the feed of content that violates one or more advertising policies comprises:
retrieving information stored by the online system describing the set of advertisements previously presented to the user;
determining whether the advertisement has at least a threshold measure of similarity to one or more advertisements in a subset of the set; and
determining the penalty based at least in part on the determination.

16. The method of claim 10, wherein the penalty is based on a predicted decrease in an amount of user interaction with the plurality of content items included in the feed from inserting the advertisement into the position in the feed of content that violates one or more of the advertising policies.

17. The method of claim 10, wherein the penalty comprises a product of a mean of a distribution of revenue generated from previously presenting the set of advertisements to the user and a coefficient correlated with a degree to which one or more of the advertising policies may be violated.

18. The method of claim 10, wherein computing the value for the advertisement comprises:
adjusting the bid amount included in the ad request including the advertisement by a position discount associated with inserting the advertisement into the position that violates an advertising policy; and
decreasing the adjusted bid amount by the penalty.

19. The method of claim 18, wherein comparing the value to one or more values comprises:
modifying the bid amount included in the ad request including the advertisement by an alternative position discount associated with inserting the advertisement into an alternative position that complies with the advertising policies; and
comparing the decreased adjusted bid amount to the modified bid amount.

20. The method of claim 10, wherein selecting content for insertion into the position based on the comparison comprises:
ranking the advertisement among one or more additional advertisements and the set of content items eligible for presentation to the user based at least in part on the comparison; and
selecting content for insertion into the position based at least in part on the ranking.

21. A computer program product comprising a computer readable storage medium having instructions encoded thereon that, when executed by a processor, cause the processor to:
enforce, at an online system, one or more advertising policies, each advertising policy describing one or more conditions preventing insertion of one or more advertisements into a position in a feed of content;
receive information describing an advertisement request from an advertiser, the advertisement request including an advertisement and a bid amount;
receive a request to present a feed of content to a user of the online system, the feed of content including one or more advertisements and a plurality of content items;
determine a penalty for inserting the advertisement into a position in the feed that violates one or more advertising policies, the penalty based at least in part on information describing a set of historical advertisements presented to the user;
compute a value for the advertisement, the value based at least in part on decreasing the bid amount by the penalty;
compare the value to one or more values associated with a set of content items eligible for insertion into the position; and
select content for insertion into the position based at least in part on the comparison.
